(19) United States
(12) Patent Application Publication
(10) Pub. No.: US 2008/0052302 A1
(43) Pub. Date: Feb. 28, 2008

(54) Managing clusters of trading locations

(75) Inventors: Shawn Dolley, Arlington, VA (US); Natarajan T. Saikumar, Asburn, VA (US); Paul M. Springmann, Orlando, FL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Vision Chain, Washington, DC (US)

(21) Appl. No.: 11/892,523

(22) Filed: Aug. 23, 2007

Related U.S. Application Data
(60) Provisional application No. 60/839,671, filed on Aug. 24, 2006.

(51) Int. Cl. G06F 17/30

(52) U.S. Cl. 707/100; 707/E17.001

(57) ABSTRACT

A method and system of creating and populating clusters of retail stores or trading locations, using qualitative or quantitative data such as store performance, historical data, demographic etc. is described herein. A user specifies criteria, which is applied to store data. Cluster definitions are acquired from user defined metadata and correlated to new and changing stores.

This application claims benefit of provisional application 60/839,671 filed on Aug. 24, 2006, which is incorporated by reference in its entirety herein.

### BACKGROUND OF THE INVENTION

1. Field of the Invention

The present invention generally relates to supply chain management and more specifically to cluster optimization.

2. Related Art

In the last two decades, there has been a trend toward consolidation among retail companies worldwide and in the United States. This consolidation has led to businesses which maintain hundreds or thousands of stores; previously, the typical larger retailers maintained tens or a few hundred stores. In the current paradigm, the consolidation has led to economies of scale. In these economies, retailers can now apply investments toward optimizing the products on each and every shelf spot in ways that were not profitable in the past. However, distribution costs and a lack of elegant methods have kept retailers from treating similar stores in their natural groupings. As a result, most store groups or ‘clusters’ tend to be tied to the cheapest distribution approach, which is geographical. In a geographical approach, stores located near each other—for example in the same U.S. state—are treated as a group, even though consumer product tastes, climate, consumer income and buying patterns, and other factors are different. For example, in a state such as Virginia, these differences can be seen. In the northern part of the state, income is higher, residents are more politically liberal, and urban and suburban life is the rule. In the southern part of the state, consumer tastes run toward outdoor life, it is rural, consumer incomes are lower and tastes are different. However, because retail stores catering to these areas are close together relative to other parts of the country, they are likely to be distributed to by the same specific carriers, carry the same products, and be managed similarly—even though the consumers in the two regions are likely willing to pay different prices, want different products on the shelves, and respond to promotions differently.

When businesses have tried to overcome the basic geographic approach, it is typically hard to manage the non-contiguous clusters. As a result, the approach is typically to assign at a single point-in-time each trading location to a specific cluster. These clusters have the limitation of being decided on in advance by a human, who may or may not have experience with the attributes of that store or those products or those consumers, or understand the purchasing behavior that are relevant and should be used to decide on the cluster definition or break points. Once the exercise is completed and any value has been attained, the records of the clusters are not maintained and do not apply to new or changed stores, and often do not have current information to help manually or automatically re-assign locations to clusters.

Current approaches have attempted solutions that avoid a comprehensive approach because of the aforementioned difficultly in managing clusters and their members. These difficulties include but are not limited to

a) The member pool of trading locations is constantly changing, include new stores, de-listed stores, and stores that have some attribute about them that has changed; such as size, type, years since refurbishing, proximity of a competitor's store, or other.

b) The consumer traits near the trading locations is constantly changing, including income levels, ethnic or demographic or psycho-demographic mixes, or other.

c) Other attributes about the store change including climate, government, regulations or laws, product availability, and more.

d) The number of users that desire to do clustering to drive optimization—such as for targeted promotions, loyalty marketing, new types of distribution, more targeted product assortment, and more—are increasing dramatically, raising and changing the requirements for cluster management faster than it can be solved or implemented.

e) The number of stores in the pool is increasing dramatically.

f) Typical data modeling methods if applied to this problem would lead to huge volumes of storage being required and long processing times.

As a result of these challenges, there are no existing methods for resolving these challenges in a single system that can reduce storage size and performance time, while accommodating multiple types of user requirements, among the environment of ever-changing qualitative and quantitative attributes.

Thus, methods and systems are needed to overcome the above mentioned deficiencies.

### BRIEF DESCRIPTION OF THE DRAWINGS/FIGURES

The features and advantages of the present invention will become more apparent from the detailed description set forth below when taken in conjunction with the drawings in which like reference numbers indicate identical or functionally similar elements.

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a diagram of an example of a regional distribution chain within a retail company and the stores served by each distribution center.

FIG. 2 illustrates example store clusters superimposed over a map of the United States.

FIG. 3 illustrates a mapping of states map to multiple clusters, and clusters that have multiple states within them.

FIG. 4 illustrates an example graphical user interface to enable a user to create store clusters according to an embodiment of the invention.

FIG. 5 illustrates a flowchart showing steps to load various data leading to and following the running of the cluster population and update algorithm—shown in detail in FIG. 8—, as well as other data movement exercises around the population and update algorithm.

FIG. 6 illustrates a data structure to accommodate the metadata around user-defined clusters according to an embodiment of the invention.

FIG. 7 illustrates a relational data model according to an embodiment of the invention.

FIG. 8 illustrates a flowchart showing steps to populate store clusters according to an embodiment of the invention.

FIG. 9 illustrates an example system according to an embodiment of the invention.

The present invention will now be described with reference to the accompanying drawings.

### DETAILED DESCRIPTION OF THE PREFERRED EMBODIMENTS

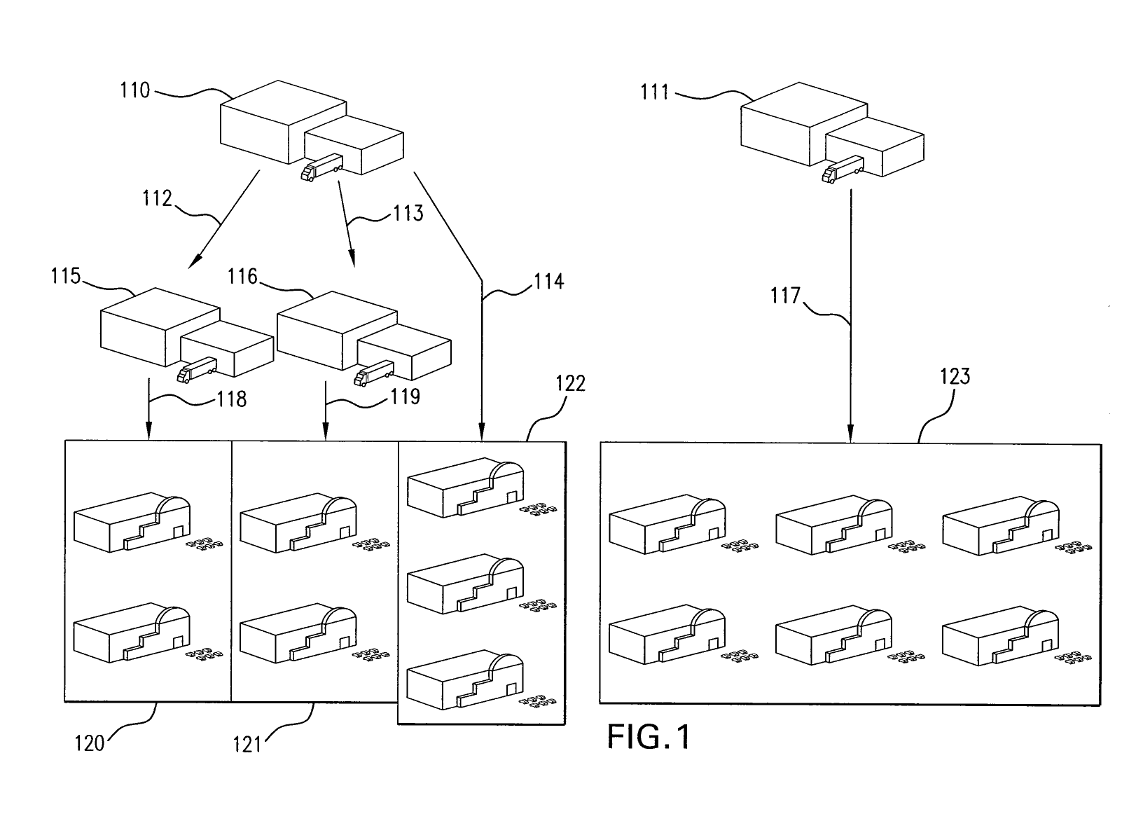

FIG. 1 is a diagram of an example of a regional distribution chain within a retail company and the stores served by each distribution center. The environment in which the present invention exists is a typical large retail business and its supply chain. In the typical retail supply chain (FIG. 1), the most important store groupings—and the ones cheapest and most easily distributed to and grouped to a cluster—are the stores served by a primary distribution center (DC) (110,111). Sometimes stores are served by trucks (118,119) coming from a secondary DC (115,116), but the impact of that distribution is likely nominal. Typically, a DC will service from ten to one hundred stores (120,121,122,123). The primary DC (110,111) houses hundreds of thousands square feet—if not more—of inventory. From this inventory is plucked the needs of each serviced store, put on a truck and delivered to the store (114,117). At times a retailer may have a second ‘tier’ of DC's which service a small number of stores each; and the major DC's would send products out to both stores (114,117) and the second tier DC's (112,113), who would then truck product to their store groups (118,119). At times, product gets to stores using methods other than trucks; it can also come from places other than a distribution center. It is to be appreciated that the source of a product or the means of distribution is arbitrary and may change. In the distribution network in FIG. 1, the store groups are as follows:

a) Stores in areas 120,121,122 belong to primary DC 110

b) Stores in areas 123 belong to primary DC 111

In embodiments presented herein priority is assigned to enabling the alignment, recording, hosting, maintaining and using store groups that cross distribution centers. For example, if three stores from area 123 and one store from 122 were similar—and in such a manner different from all the other stores shown—, then this smaller group would represent a store cluster untied to the distribution center store cluster represented by the group labeled 123. A store cluster could exist within a single DC mapping, but it need not.

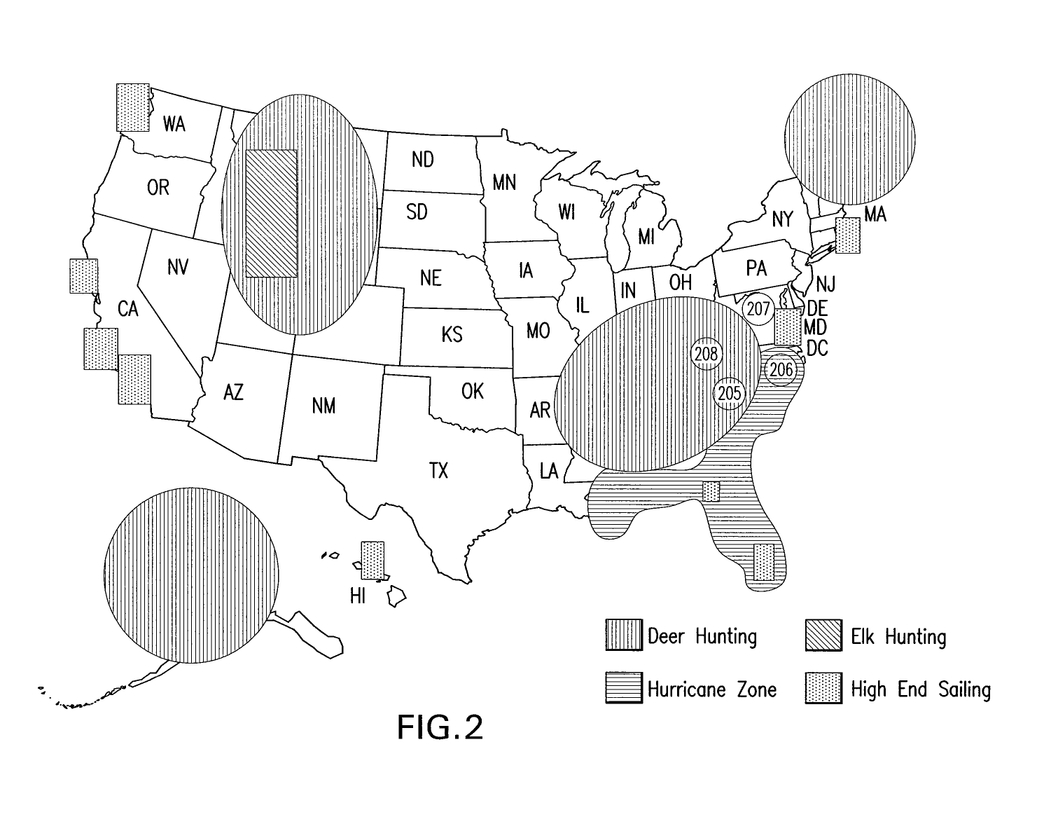

FIG. 2 illustrates example store clusters superimposed over a map of the United States. The clusters include high indices of consumers who participate in certain activities or have other climate conditions. In the diagram, a retailer has stores throughout all 50 states of the United States. The retailer has decided to assign stores to two different types of clusters. One is weather related, the other lifestyle or hobby related. In the diagram, the retailer has labeled certain geographic areas as deer hunting areas, i.e. regions where a popular sport—and one likely to be engaged in by customers—is hunting deer. Alternately they have identified another region for elk hunting. As such, stores that fall outside of both areas would be listed as not in a hunting cluster. The stores in one of the two clusters would be identified accordingly. Finally if any stores fell inside both clusters, they would be tagged as members of both. In the states of Virginia, North Carolina, and South Carolina on the diagram, stores 205, 206, and 207 are labeled. Store 207 is not a member of the hurricane cluster, nor a member of the deer hunting cluster, both of which are nearby. Store 206 is a hurricane store but not a deer hunting store. Store 205 is in both areas. It is possible that all three stores are served by a single distribution center labeled 208. Of further notice is that since two clusters are both hunting-related, a superset of the stores in those areas could be tagged to a higher level or aggregate cluster called ‘Hunting Stores’. This second level type of hierarchy is one of the challenges to managing clusters to which this invention can be applied.

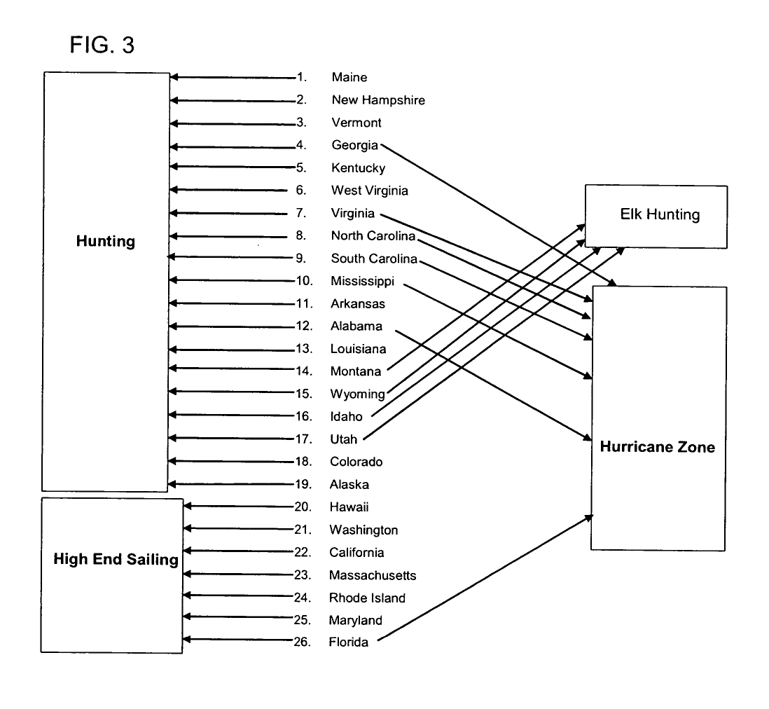

FIG. 3 illustrates a mapping of states map to multiple clusters, and clusters that have multiple states within them.

This data relates to the pictorial geographic map in FIG. 2. In FIG. 3, one can see that some stores belong to multiple clusters. An example of this is that Florida is in both the Hurricane Zone cluster and the High End Sailing cluster. Also, one can see that a cluster—such as Hunting—can have many states. This kind of relationship between states and clusters is called ‘many-to-many’, that is a cluster can have many states and a state can be in many clusters. This kind of relationship raises challenges in creating data structures to store clusters and their population of trading locations, which embodiments presented herein serve to resolve. The example use of states here rather than stores is to illustrate a simpler set of mappings in FIG. 2 and FIG. 3. In the processing involved, for example, each state owns a set of stores, and the states in a cluster like Hunting would be resolved down to the stores existing in those states.

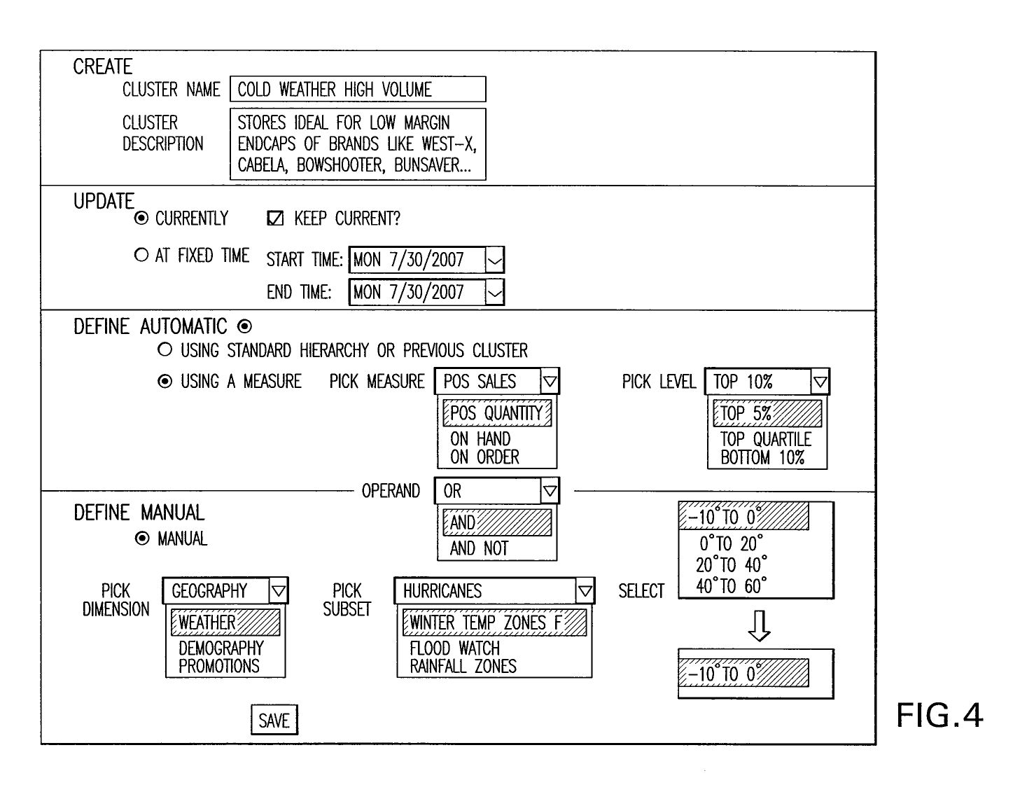

FIG. 4 illustrates an example graphical user interface to enable a user to create store clusters according to an embodiment of the invention. Creating a cluster comprises enabling a user to author, select, or revise definitions of parameters that will be applied to the entire or subsets of the universe of potential stores. Creating clusters is different than populating clusters in that populating clusters is finding all the stores that meet the criteria that is defining in the clusters that have been created. In the user interface in FIG. 4, the user first must decide if the cluster is to be fixed and never updated, or if it is to be refreshed at intervals—this is done in the ‘Update’ section. Refreshing the cluster means the population will change, based on changes in the stores that have those attributes defined in the cluster parameters. The parameters remain fixed, but the stores that qualify change. In an embodiment, once a cluster is defined it cannot be changed—the parameters are fixed—and if the user wants to create a slightly different cluster they must create a new one with this new definition. In an alternate embodiment, a user can modify a parameter defining a cluster.

A cluster has one historical and current update selection. Once the user decides how the cluster population will change or not, the user has the opportunity to add one or more types of qualifications. The types are automatic or manual. In the automatic type—shown in the ‘Define Automatic’ section—the user will select either a hierarchy qualification or a measure qualification. These selections are automatic because they rely on previously stored user metadata about what measures can define a store, or what stores exist in pre-defined groupings. By applying one of these pre-defined groupings (‘hierarchies’) or measures, the user automatically applies a previous definition. Examples of standard groupings or measures are as follows

a) Standard measures are predetermined formulas for the purposes of reporting and analytics. These can be simple direct calculations provided in the factual actual event data. An example of this would be the purveyor of retail stores viewing, or passing along to another company for view, simple facts such as quantity sold. A more complicated formula would be based on quantity sold such as inventory turnover, where the viewer calculates the amount sold compared to an average inventory for that item to understand how often the inventory is sold through over a period of time. Examples of standard measures include but are not limited to calculations for sales dollars, gross margin, count of customers, net profit, point-of-sale quantity, on hand quantity and on order quantity,

b) Standard groupings or ‘hierarchies’ include the relationships a retailer uses in other parts of its business. For example, when a retailer reports sales internally or to the stock market it may trade on, it groups stores into regions to provide aggregate sales calculations for periods of times for those regions. The maps of stores in each region for this purpose would comprise a standard hierarchy. For example, in FIG. 1, distribution center 110 forms the top level of the hierarchy, with secondary distribution centers 115, 116 forming the second level hierarchy. Stores 120, 121 and 122 form the third level hierarchy. If a user selects stores in DC 110, then all stores in 120, 121 and 122 are selected. If a user selects stores in DC 115, then all stores in 120 are selected. If a user selects stores in DC 116 then stores in 121 are selected. If a user selects DC 111 then all stores in 123 are selected. Typically hierarchies such as these pre-exist, making it possible for a user to select a member or level of these hierarchies.

The user also can define a custom or manual cluster qualification. In this mode, the user accesses existing cluster definitions, including the broad type of cluster, as well as the cluster levels or ‘subsets’ in the cluster. Finally, the user must choose an operand to define the logical between the automatic and standard portions of the qualification. This could be ‘OR’, which would sum both the stores qualifying for the automatic parameters, or ‘AND’ which would intersect the two groups and only take the common stores.

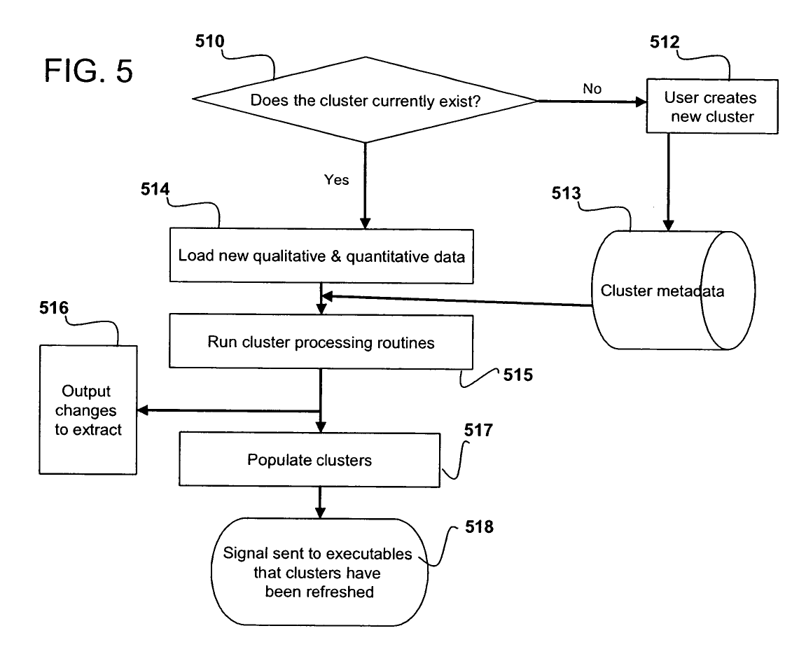

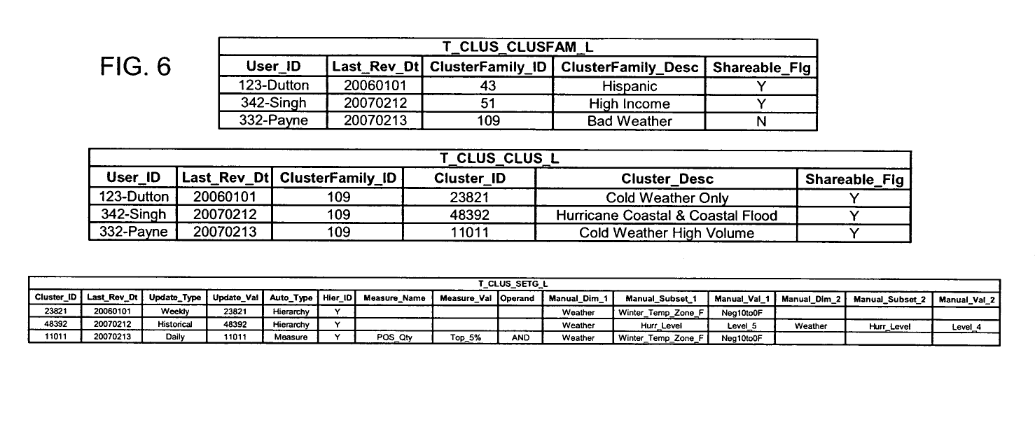

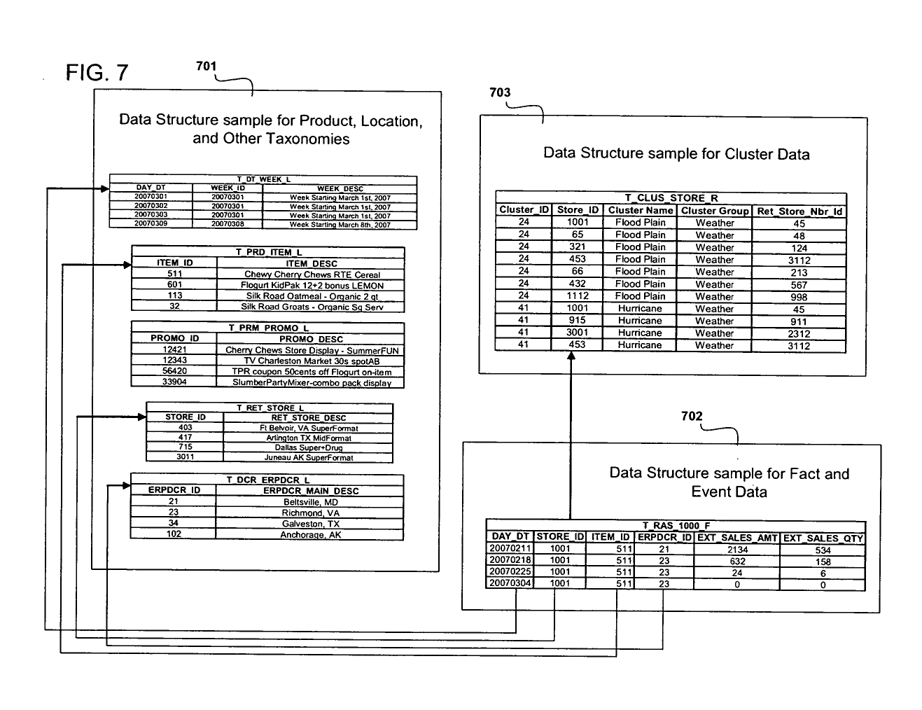

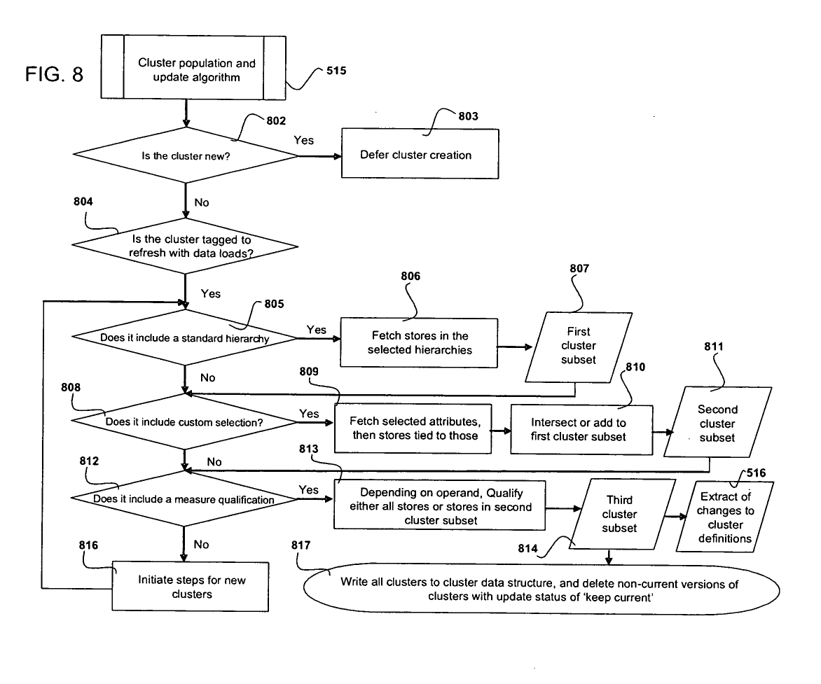

FIG. 5 illustrates high-level steps to create, populate and refresh clusters according to an embodiment of the invention. FIG. 5 shows a high-level series of steps the invention uses to both load new hierarchy and explicit event or ‘fact’ data, as well as moves through a process to define the clusters. In step 510, the user looks to see if a cluster already exists for their analysis or distribution execution. If not, then in step 512, the user creates a new cluster using a user interface such as shown in FIG. 4 The records quantitatively describing a cluster are recorded—in step 513—in a data structure such as in FIG. 6. Once done, the process moves to the actual population of the clusters, which is done in step 515, and outlined in detail in FIG. 8. If a cluster does exist for the user's purpose, the process simply goes to step 514, where the new hierarchical data and explicit event data, as might be stored in the data structure 701 and 702 of FIG. 7, are loaded or refreshed. In step 515, the algorithm to apply cluster parameters to the data executes, and as a result step 517 occurs, which is that the clusters are populated into data structures such as is shown in group 703 of FIG. 7. In step 516—as also mentioned in FIG. 8, the delta between the previous cluster population—if it had been populated previously—is output to a file. In step 518 a signal is sent out to waiting applications that the clusters have been refreshed and they can fetch the new populations for their uses.

FIG. 6 illustrates a data structure to accommodate the metadata around user-defined clusters according to an embodiment of the invention. User defined settings for clusters would be set in a graphical user interface such as in FIG. 4. Once the cluster definition and settings are entered, they need to be stored relationally in a data model. In the data model in FIG. 6, the following fields are illustrated in the data structure:

1. User_ID is a field that records the business user identification of the owner and creator of the cluster family described in the Cluster Family table. This field exists in the T_CLUS_CLUSFAM_L table.

2. Last_Rev_Dt is a field that updates with the most recent date that the owner of this cluster family has changed some variable about this cluster family. This field exists in the T_CLUS_CLUSFAM_L table.

3. Cluster_Family_ID is a unique numeric identifier that records a specific cluster family that has been created and described by this user. This field exists in the T_CLUS_CLUSFAM_L table.

4. ClusterFamily_Desc is a text description of the cluster family that the user is creating. A Cluster Family is a logical grouping of clusters. By having a logical grouping of clusters, business owners can more easily view, report on, customize or otherwise manipulate store clusters in their environment. This field exists in the T_CLUS_CLUSFAM_L table.

5. Shareable_Flg This field exists in the T_CLUS_CLUSFAM_L table.

6. User_ID is a field that records the business user identification of the owner and creator of the cluster described in the Cluster table. This field exists in the T_CLUS_CLUS_L table.

7. Last_Rev_Dt is a field that updates with the most recent date that the owner of this cluster has changed some variable about this cluster. This field exists in the T_CLUS_CLUS_L table.

8. ClusterFamily_ID is a unique numeric identifier that refers back to the single cluster family that this cluster rolls up to. This field exists in the T_CLUS_CLUS_L table.

9. Cluster_ID is a unique numeric identifier of a single cluster the user is creating and defining as part of this invention. This field exists in the T_CLUS_CLUS_L table.

10. Cluster_Desc is a text description of the cluster the user is creating and defining. This field exists in the T_CLUS_CLUS_L table.

11. Shareable_Flg is a field that is a yes or no value that defines whether the owner and creator of this cluster has decided to let other users view this cluster. This field exists in the T_CLUS_CLUS_L table.

12. Cluster_ID is a unique numeric identifier of a single cluster the user is creating and defining as part of this invention. In this table it serves to define the cluster about which all the variables are describing. This field exists in the T_CLUS_SETG_L table.

13. Last_Rev_Dt is a field that updates with the most recent date that the owner of these cluster settings has changed some variables in these cluster settings. This field exists in the T_CLUS_SETG_L table.

14. Update_Type is a field describing if or how the user wants the cluster to change over time. For example, the user might want the cluster to be ‘fixed’ in time. An example of this would be if the cluster should be all the stores in high income zip codes as those zip codes were ranked in 2005. The stores in this cluster would never change. Alternately, a user might want to craft a high income cluster that constantly changes its stores as new stores come in, old stores close and as zip codes change their median income. Thus, this field enables a user to record information about how a cluster would update or not. This field exists in the T_CLUS_SETG_L table.

15. Update_Val is a field that describes the specific setting of the update qualification once the update type is known from the Update_Type field. An example update value is if the Update Type is fixed, the Update_Val field would hold a time of record at which the stores are named to the cluster. This field exists in the T_CLUS_SETG_L table.

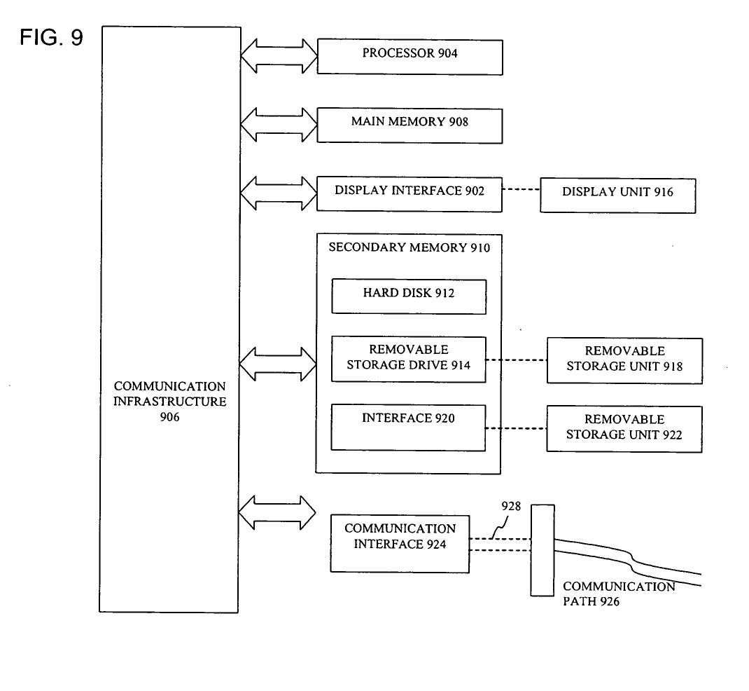

16. Auto_Type is a field that defines whether the user—in a user interface like that in FIG. 4—wants to in the automatic approach of cluster generation use a pre-defined hierarchy or ‘taxonomy’, or whether they want the hierarchy to automatically update using some level of a key measure. If the Automatic Type is a hierarchy, the cluster will reference geographies and other attributes from a table such as T_PRD_ITEM_L in FIG. 9. Alternately, the user can set the Auto Type to indicate it is a measure's value driving the stores in the cluster. This field exists in the T_CLUS_SETG_L table.

17. Hier_ID is a field that lists the hierarchy that defines the stores in this cluster when driven automatically by hierarchy definition. These hierarchies or organizational taxonomies are updated by means outside this invention in traditional ways using files amongst the typical point-of-sale and demand data transfers among supply chain partners. An example of a hierarchy might be US State. In that hierarchy, all the stores with a parent state of Alabama would be listed in a cluster of ‘Alabama’. This field exists in the T_CLUS_SETG_L table.

18. Measure_Name is a field populated only if the Auto Type field includes the user choosing to drive the cluster with the value of a measure. In this approach, the user might want to only include in the cluster those stores with sales in the top 5% of all stores in the retail chain. The elegance of this approach is that as new stores come in or consumption patterns change, stores will enter or fall out of the cluster based on their performance relative to the whole chain. This field exists in the T_CLUS_SETG_L table.

19. Measure_Val is a numerical field with the specific set point that includes a store in this cluster. In the example mentioned in number 18 of this section—Measure_Name—the Measure_Val would be the ‘5%’ of the Top 5% of stores. The value in this field will be populated into the clustering algorithm that populates stores to clusters and records them. This field exists in the T_CLUS_SETG_L table.

20. Operand is a field that defines the logical tie between the automatic setting(s) and manual setting(s) of the cluster. This exists in the T_CLUS_SETG_L table.

21. Manual_Dim_{—}1 is a field that records the user's setting for the first dimension that defines the cluster. For example, this might be Geography, Promotion, or Weather. A dimension is the broadest grouping of factual attributes that exist ultimately at the store shelf level. This exists in the T_CLUS_SETG_L table.

22. Manual_Subset_{—}1 is a field that records the user's setting for the subset of the first dimension that defines the cluster. This exists in the T_CLUS_SETG_L table.

23. Manual_Val_{—}1 is a field that records the user's setting for the exception value that defines a cluster criterion in the first dimension and first dimension subset. This exists in the T_CLUS_SETG_L table.

24. Manual_Dim_{—}2 is a field that records the user's setting for the second dimension that defines the cluster. For example, this might be Geography, Promotion, or Weather. A dimension is the broadest grouping of factual attributes that exist ultimately at the store shelf level. This exists in the T_CLUS_SETG_L table.

25. Manual_Subset_{—}2 is a field that records the user's setting for the subset of the second dimension that defines the cluster. This exists in the T_CLUS_SETG_L table.

26. Manual_Val_{—}2 is a field that records the user's setting for the exception value that defines a cluster criterion in the second dimension and second dimension subset. This exists in the T_CLUS_SETG_L table.

FIG. 7 illustrates a relational data model according to an embodiment of the invention. The sample data structures illustrated in FIG. 7 are used to relationally store i) data created by business users defining standard taxonomies or ‘hierarchies’ for stores, items and other parts of a consumer supply chain, ii) explicit supply chain events (i.e. ‘fact data’), and iii) cluster populations of stores. This is a structure that handles the optimized model for holding multiple clusters relationally in a compact space while enabling all the business user requirements. In it there are three groupings of tables. Group 701 includes the hierarchies or taxonomies that change less frequently than weekly or daily, and describe supply chain attributes like products, stores, or distribution centers. Group 702 is a structure for ‘fact’ or transactional data—data that comes in fresh daily or weekly and describes purchase or inventory transactions by store, item, consumer, or other key attributes. Group 703 is the data structure for clusters. Here we can see what can be called a ‘relationship’ table where multiple clusters can exist in the same table, with clusters repeating rows as needed, and multiple stores can exist in the table, with stores repeating rows as needed. The primary key—or field or combination of fields required to uniquely identify any row—is both Cluster_ID and Store_ID. This enables a single table to hold a large number of changing clusters and tie back to measured data that might qualify cluster entry, for example, the Store_ID to Store_ID link from Group 703 to 702 shows.

FIG. 8 illustrates steps to populate a cluster according to an embodiment of the invention. The store clusters are populated according to the defining parameters entered by a user via the interface shown in FIG. 4 and stored in the data structure shown in FIG. 6. The process begins with step 515 which is referenced in FIG. 5. Step 515 is further defined in the flowchart illustrated in FIG. 8.

In step 802 it is determined whether a cluster is a new cluster. The process starts with splitting out the clusters that are new, in order to first populate or ‘refresh’ the definitions of existing clusters. This helps a number of things, including focusing on clusters likely to be in wider use first, as well as taking care of processes that are likely to be completed more quickly—since stores move in and out of clusters less than the processing time for a brand new cluster. The new cluster records are set aside in step 803 to be populated after the existing clusters. In step 804, existing clusters are not modified. For the existing clusters, all clusters that have previously fixed populations are exempt from updates based on new store characteristics, new hierarchy definitions, and changes in store performance as evinced in the fact data. These are ignored in step 804. In step 805, it is determined whether a cluster includes a standard hierarchy. By step 805, the remaining clusters will be non-new clusters that need to be refreshed. In step 805, the clusters where the user has selected to limit them by some standard hierarchy are selected for pre-processing. There is an advantage in ordering the process to have step 805 come prior to step 808, and to have steps 805 and 808 prior to step 812, in cases where the operand between the portions of the cluster definition is AND (as seen in FIG. 4). The advantage is to identify which steps have the most complicated processing—such as running statistical tests or what is conventionally referred to as ‘multi-pass structured query language’—and making the order such that these steps are the final ones. By making the earlier steps be fast, simple limiting steps, this allows later, slower steps to run against smaller subsets of data. Consider two processes: 1) where the user has decided to first select a cluster that has stores active in 2007 (standard hierarchy) and then from the subset of stores active in 2007 select stores where the gross margin is greater than 32% (measure qualification) and 2) where the user has decided to first select a cluster that has stores with a gross margin of greater than 32% (measure qualification) and then select stores from the subset of stores having gross margin greater than 32%, stores that are active in 2007 (standard hierarchy). In the second process, the gross margin calculation is done first, then the store active in 2007 limitation. In this case, the processor must identify every single store which could number in the hundreds or thousands, then calculate gross margins. Once this subset of those stores with greater gross margins than 32% are selected and put into a table or array, the processor looks for stores within that group that were active in 2007, a simple calculation. The first process, an alternate one, would be for the processor to first find the active stores, then do the gross margin calculations. If for example only half the total stores were active, then doing the second process rather than the first would cut the time taken for the gross margin calculation in half: a significant time savings by doing the processing for simpler calculations and processing first, such as we include here by having step 805 come first. Steps 806, 809, and 813 candidate stores that qualify for the cluster are filtered by applying cluster parameters to exclude non qualifying stores. As such, after steps 806, 809, and 813, the stores qualifying to be in the cluster may be smaller than the universe applicable before that step. In step 806, the entire universe of stores is reduced to those stores that belong to the hierarchies selected for the cluster in question. The qualifying stores are exported to an array or table in step 807 to be used as the new universe to be further cut or added to depending in the operand, in step 810. In step 808, the cluster is evaluated to see if the output in step 807 is the final cluster population. The first step to determining if the cluster population is complete is to check the cluster definition—as recorded in a data structure such as shown in FIG. 6—by checking to see if the cluster definition includes a user qualifying the cluster by a custom selection. If yes, then step 809 processes the entire universe and populates that to an array or table. Cluster metadata is checked in step 810 to determine the operand that defines if the first cluster subset as exists in step 807 will be added to the output from step 809 (i.e. an ‘OR’ operation), or if only the common stores (i.e. an ‘AND’ operation) between the step 809 output will be added to the stores in step 807. Once this logic is applied, the new cluster population is stored in step 811 in a second cluster subset. Next, the cluster needs to be evaluated to see if it is complete, so in step 812 the process checks to see if the cluster includes the final and most processing-intensive type of qualification: a measure parameter. A measure parameter or ‘qualification’ would be what a user selects in FIG. 4 called Automatic, Choosing A Measure. An example of a measure parameter is if a user selected stores with a gross margin greater than 32%, as described above. If the cluster definition does include a measure parameter, then the algorithm checks the operand first, and if it is an AND operation (as in FIG. 4), then it runs against the second cluster subset from step 811. This checking of the operand first means the process has a chance to run on a smaller subset of data first, making the entire process faster. The final cluster population then is complete and exists in step 814 in an output table. The delta of this population versus the previous cluster population is output in step 516 (referencing FIG. 5) to an extract file and stored for audit purposes as well as for users to view if they desire to see exactly how the cluster changed when it was refreshed. In step 816, once the existing clusters have been filtered, the process is repeated for new clusters by returning control to step 805. When the final third cluster subset is complete in step 814 for all the new clusters, the process terminates with the actions in step 817 by deleting the cluster populations that were output from previous and historical iterations, in favor of the new and up-to-date populations for those self-same refreshable clusters, and all the cluster populations are now exported to the tables such as shown in FIG. 7.

It is to be appreciated by a person of skill in the art the term ‘store’ is used rather than trading location not to limit the invention, but to describe the invention more compactly and relating to the type of trading location it would be most commonly used for. Embodiments presented herein will be applicable to other trading locations than stores.

FIG. 9 diagrams a general purpose computer system and is provided for completeness. The present invention can be implemented in hardware, or as a combination of software and hardware. Alternatively, embodiments may be implemented in the environment of a computer system or other processing system as illustrated in FIG. 10. The computer system includes one or more processors, such as processor 904. Processor 904 can be a special purpose or a general purpose digital signal processor. The processor 904 is connected to a communication infrastructure 906 (for example, a bus or network). Various software implementations are described in terms of this exemplary computer system. After reading this description, it will become apparent to a person skilled in the relevant art how to implement the invention using other computer systems and/or computer architectures.

The computer system also includes a main memory 908, preferably random access memory (RAM), and may also include a secondary memory 910. The secondary memory 908 may include, for example, a hard disk drive 912, and/or a RAID array 916, and/or a removable storage drive 914, representing a floppy disk drive, a magnetic tape drive, an optical disk drive, etc. The removable storage drive 914 reads from and/or writes to a removable storage unit 918 in a well known manner. Removable storage unit 918 represents a floppy disk, magnetic tape, optical disk, etc. As will be appreciated, the removable storage unit 918 includes a computer usable storage medium having stored therein computer software and/or data.

In alternative implementations, secondary memory 910 may include other similar means for allowing computer programs or other instructions to be loaded into the computer system. Such means may include, for example, a removable storage unit 922 and an interface 920. Examples of such means may include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to the computer system.

The computer system may also include a communications interface 924. Communications interface 924 allows software and data to be transferred between the computer system and external devices. Examples of communications interface 924 may include a modem, a network interface (such as an Ethernet card), a communications port, a PCMCIA slot and card, etc. Software and data transferred via communications interface 924 are in the form of signals 928 which may be electronic, electromagnetic, and optical or other signals capable of being received by communications interface 924. These signals 928 are provided to communications interface 924 via a communications path 926. Communications path 926 carries signals 928 and may be implemented using wire or cable, fiber optics, a phone line, a cellular phone link, an RF link and other communications channels.

The terms “computer program medium” and “computer usable medium” are used herein to generally refer to media such as removable storage drive 914, a hard disk installed in hard disk drive 912, and signals 928. These computer program products are means for providing software to the computer system.

Computer programs (also called computer control logic) are stored in main memory 908 and/or secondary memory 910. Computer programs may also be received via communications interface 924. Such computer programs, when executed, enable the computer system to implement the present invention as discussed herein. In particular, the computer programs, when executed, enable the processor 904 to implement the processes of the present invention. Where the invention is implemented using software, the software may be stored in a computer program product and loaded into secondary memory 910 using raid array 916, removable storage drive 914, hard drive 912 or communications interface 924.

In an embodiment, one or more of main memory 908, secondary memory 910, and removable storages units 918 and 922 storing processing instructions for directing processor 904 to accept user input determining whether stores in a cluster are to be refreshed periodically or perpetually, accept user input selecting whether the cluster is to include stores from a hierarchy of stores or from a previously defined cluster of stores, accept user input selecting one or more predetermined measures for stores to be included in the cluster, accept user input selecting one or more custom parameters for stores to be included in the cluster and accept user-input defining a cluster comprising stores. The memory also includes instructions for directing processor 904 to add stores from the user-selected predetermined grouping of stores to form a first subset of stores, add or subtract stores to the first subset of stores based on the user-selected custom parameters for stores to form a second subset of stores, add or subtract stores to the second subset of stores based on the user-selected predetermined measures for stores to form a third subset of stores, and populate a data structure with the third subset of stores to form a populated cluster of stores. The custom parameters include but are not limited to one or more of geographical, demographical or promotional parameters. The predetermined measures include but are not limited to on or more of Point of Sale (POS) quantity, on hand quantity and on order quantity for a product.

In other embodiments, features of the invention are implemented primarily in hardware using, for example, hardware components such as Application Specific Integrated Circuits (ASICs) and gate arrays. Implementation of a hardware state machine so as to perform the functions described herein will also be apparent to persons skilled in the relevant art(s).

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of populating a cluster of stores, comprising:
adding stores from a user-selected predetermined grouping of stores to form a first subset of stores;
adding or subtracting stores to or from the first subset based on user-selected custom parameters for stores to form a second subset of stores;
adding or subtracting stores to or from the second subset of stores based on user-selected predetermined measures for stores to form a third subset of stores; and
populating a data structure with the third subset of stores to form a populated cluster of stores.

2. The method of claim 1, further comprising:
accepting user input determining whether stores in the cluster are to be refreshed periodically or perpetually;
accepting user input selecting whether the cluster is to include stores from a hierarchy of stores or from a previously defined cluster of stores;
accepting user input selecting one or more predetermined measures for stores to be included in the cluster;
accepting user input selecting one or more custom parameters for stores to be included in the cluster; and
accepting user-input defining a cluster name and description.

3. The method claim 1, further comprising the steps of:
determining whether the cluster is a new cluster or an existing cluster;
determining whether the user specified a predetermined grouping of stores to be included in the cluster;
determining whether the user specified custom parameters for stores to be included in the cluster; and
determining whether the user specified a predetermined measure for stores to be included in the cluster.

4. The method of claim 1, wherein the custom parameters include one or more of geographical, demographical or promotional parameters.

5. The method of claim 1, wherein predetermined measures include on or more of Point of Sale (POS) quantity, on hand quantity and on order quantity for a product.

6. The method of claim 1, wherein the data structure is a relationship table with each entry in the table identified by a cluster identification and store identification.

7. A system to create a cluster of stores, comprising:
a processor;
a memory in communication with the processor, the memory for storing a plurality of processing instructions for directing the processor to:
accept user input determining whether stores in the cluster are to be refreshed periodically or perpetually;
accept user input selecting whether the cluster is to include stores from a hierarchy of stores or from a previously defined cluster of stores;
accept user input selecting one or more predetermined measures for stores to be included in the cluster;
accept user input selecting one or more custom parameters for stores to be included in the cluster; and
accept user-input defining a cluster comprising stores.

8. The system of claim 7, wherein the memory further comprises instructions for directing the processor to:
add stores from the user-selected predetermined grouping of stores to form a first subset of stores;
add or subtract stores to or from the first subset of stores based on the user-selected custom parameters for stores to form a second subset of stores;
add or subtract stores to or from the second subset of stores based on the user-selected predetermined measures for stores to form a third subset of stores; and populate a data structure with the third subset of stores to form a populated cluster of stores.

9. The system of claim 7, wherein the custom parameters include one or more of geographical, demographical or promotional parameters.

10. The system of claim 7, wherein the predetermined measures include on or more of Point of Sale (POS) quantity, on hand quantity and on order quantity for a product.

11. The system of claim 8, wherein the data structure is a relationship table with each entry in the table identified by a cluster identification and store identification.

12. A computer program product comprising a computer useable medium including control logic stored therein for creating a Graphical User Input (GUI) to accept user input to create a cluster of stores comprising:
first control logic means for causing a computer to accept user input determining whether stores in the cluster are to be refreshed periodically or perpetually;
second control logic means for causing a computer to accept user input selecting whether the cluster is to include stores from a hierarchy of stores or from a previously defined cluster of stores;
third control logic means for causing a computer to accept user input selecting one or more predetermined measures for stores to be included in the cluster;
fourth control logic means for causing a computer to accept user input selecting one or more custom parameters for stores to be included in the cluster; and
fifth control logic means for causing a computer to accept user-input defining a cluster comprising stores.

13. The computer program product of claim 12, further comprising:
sixth control logic means for causing a computer to add stores from the user-selected predetermined grouping of stores to form a first subset of stores.

14. The computer program product of claim 12, further comprising:
seventh control logic means for causing a computer to add or subtract stores to or from the first subset of stores based on the user-selected custom parameters for stores to form a second subset of stores.

15. The computer program product of claim 12, further comprising:
eighth control logic means for causing a computer to add or subtract stores to or from the second subset of stores based on the user-selected predetermined measures for stores to form a third subset of stores.

16. The computer program product of claim 12, further comprising:
ninth control logic means for causing a computer to populate a data structure with the third subset of stores to form a populated cluster of stores.

17. The computer program product of claim 12, wherein the custom parameters include one or more of geographical, demographical or promotional parameters.

18. The computer program product of claim 12, wherein the predetermined measures include on or more of Point of Sale (POS) quantity, on hand quantity and on order quantity for a product.

19. The computer program product of claim 16, wherein the data structure is a relationship table with each entry in the table identified by a cluster identification and store identification.

20. The computer program product of claim 12, wherein the first control logic means further comprises sixth control logic means for causing a computer to accept user input to select a start time and an end time for refreshing stores in the cluster.
